(19) United States
(12) Patent Application Publication
(10) Pub. No.: US 2021/0176065 A1
(43) Pub. Date: Jun. 10, 2021

(54) STORAGE SYSTEM AND DATA PROTECTION METHOD FOR STORAGE SYSTEM

(71) Applicant: Hitachi, Ltd., Tokyo (JP)

(72) Inventors: Nobuyuki OSAKI, Tokyo (JP); Hajime SATO, Tokyo (JP); Mioko MORIGUCHI, Tokyo (JP)

(21) Appl. No.: 17/007,007

(22) Filed: Aug. 31, 2020

(30) Foreign Application Priority Data
Dec. 4, 2019 (JP) 2019-219834

(51) Int. Cl. H04L 9/32; G06F 21/60; H04L 9/08

(52) U.S. Cl. CPC H04L 9/3226; H04L 9/0819; H04L 9/0863; G06F 21/602

(57) ABSTRACT

In writing, a storage controller generates encrypted data using a data encryption key and generates an authentication code based on the encrypted data using an authentication key. A storage node verifies the authentication code received from the storage controller. If the authentication code is successfully verified, the storage node stores the encrypted data and the authentication code. In reading, the storage controller verifies the authentication code received from the storage node. If the authentication code is successfully verified, the storage controller decrypts the encrypted data and sends the decrypted data to a host.

### CROSS-REFERENCE TO RELATED APPLICATION

The present application claims priority from Japanese application JP 2019-219834, filed on Dec. 4, 2019, the contents of which is hereby incorporated by reference into this application.

### BACKGROUND

The present invention relates to a storage system capable of authenticating encrypted data and a data protection method for the storage system.

NVMe over Fabrics is a protocol that extends NVMe (Non Volatile Memory express) transactions to a network.

In order to protect, by using NVMe over Fabrics, data to be stored in a storage node from a storage controller, it is necessary to encrypt data passing a network (hereinafter, will be referred to as communication data encryption) in addition to the encryption of data to be stored in the storage node (hereinafter, will be referred to as stored data encryption).

In this case, for sharing encryption between the storage controller and the storage node, two methods are available as follows:

In the first method, data is encrypted by the storage controller according to communication data encryption, the encrypted data is transmitted from the storage controller to the storage node via the network, the data encrypted according to communication data encryption is decrypted by the storage node, and the decrypted data is stored after being encrypted by the storage controller according to stored data encryption.

In the second method, data is encrypted by the storage controller according to stored data encryption, the encrypted data is encrypted by the storage controller according to communication data encryption, the encrypted data having undergone the double encryption of stored data encryption and communication data encryption is transmitted from the storage controller to the storage node via the network, and the encrypted data having undergone the double encryption is subjected to communication data decryption by the storage node, so that the data subjected to single encryption according to stored data encryption is stored.

Japanese Patent Application Publication No. 2006-304215 discloses a method in which an encryption unit on a PC encrypts input data with a public key and generates hash data from the data of input data, and the encrypted data is stored on a server over the network. A decryption unit on a PC gets the encrypted data over the network from the server and decrypts the encrypted data using a private key, generates hash data from the decrypted data, and confirms whether the hash data is correct or not, so that the correctness of key data is confirmed.

### SUMMARY

In the first encryption, however, it is necessary to perform communication data decryption and stored data encryption in the storage node, resulting in a heavy load to the storage node. In the second encryption, it is necessary to perform stored data encryption and communication data encryption in the storage controller, resulting in a heavy load to the storage controller.

Furthermore, Japanese Patent Application Publication No. 2006-304215 discloses that hash data is used to confirm, at a writing source, the correctness of key data used for encryption, but does not disclose a method for authenticating encrypted data at a writing destination.

The present invention has been devised in view of the circumstances. An object of the present invention is to provide a storage system and a data protection method for the storage system, by which data storage and safe communications are ensured while reducing the load of encryption.

In order to attain the object, a storage system according to a first aspect includes a controller to which an authentication key is allocated, and a node, wherein the controller is configured to generate encrypted data in which the data is encrypted using a data encryption key, generate an authentication code based on the encrypted data using the authentication key, and transmit the encrypted data and the authentication code to the node, the node is configured to receive the encrypted data and the authentication code that are transmitted from the controller, store the encrypted data and the authentication code, and transmit the encrypted data and the authentication code that are stored to the controller, and the controller is further configured to receive the encrypted data and the authentication code that are transmitted from the node, and decrypt the encrypted data based on a verification result of the authentication code transmitted from the node.

According to the present invention, data storage and safe communications are ensured while reducing the load of encryption.

### BRIEF DESCRIPTION OF THE DRAWINGS

FIG. 1 is a block diagram illustrating the configurations of a storage controller and storage nodes to which an encryption apparatus according to a first embodiment is applied;

FIG. 2 indicates an example of a mapping table used for the storage controller of FIG. 1;

FIG. 3 indicates an example of a data-encryption-key management table used for the storage controller of FIG. 1;

FIG. 4 indicates an example of an authentication-key correspondence table used for the storage controller of FIG. 1;

FIG. 5 indicates another example of the authentication-key correspondence table used for the storage controller of FIG. 1;

FIG. 6 indicates an example of an authentication code table used for the storage controller of FIG. 1;

FIG. 7 is a flowchart indicating the writing of the storage controller of FIG. 1;

FIG. 8 is a flowchart indicating the writing of the storage nodes of FIG. 1;

FIG. 9 is a flowchart indicating the reading of the storage controller of FIG. 1;

FIG. 10 is a flowchart indicating the reading of the storage nodes of FIG. 1;

FIG. 11 indicates an example of information exchanged between the storage controller and the storage nodes of FIG. 1;

FIG. 12 is a flowchart indicating the writing of a storage controller according to a second embodiment;

FIG. 13 is a flowchart indicating the reading of the storage controller according to the second embodiment;

FIG. 14 is a flowchart indicating the writing of the storage nodes according to the second embodiment;

FIG. 15 indicates a method of confirming whether a sequence number is a previously used number;

FIG. 16 is a flowchart indicating the reading of storage nodes according to the second embodiment;

FIG. 17 is a flowchart indicating the reading of a storage controller according to a third embodiment;

FIG. 18 is a flowchart indicating the reading of a storage controller according to a fourth embodiment;

FIG. 19 is a flowchart indicating the reading of a storage controller according to a fifth embodiment;

FIG. 20 is a flowchart indicating the reading of storage nodes according to a sixth embodiment;

FIG. 21 is a flowchart indicating the reading of a storage controller according to the sixth embodiment;

FIG. 22 is a block diagram illustrating the configurations of a storage controller and storage nodes to which an encryption apparatus according to a seventh embodiment is applied;

FIG. 23 is a block diagram illustrating the configurations of storage controllers and storage nodes to which an encryption apparatus according to an eighth embodiment is applied;

FIG. 24 is a block diagram illustrating the configurations of hosts and storage nodes to which an encryption apparatus according to a ninth embodiment is applied;

FIG. 25 is a block diagram illustrating the configurations of storage controllers and storage nodes to which an encryption apparatus according to a tenth embodiment is applied;

FIG. 26 is a block diagram illustrating the configurations of a storage controller and a storage to which an encryption apparatus according to an eleventh embodiment is applied; and

FIG. 27 is a block diagram illustrating a hardware configuration example of the storage controller of FIG. 1.

### DETAILED DESCRIPTION OF THE EMBODIMENTS

Embodiments will be described below with reference to the accompanying drawings. The following embodiments do not limit the invention described in the claims and all elements and combinations thereof in the embodiments are not always necessary for the solutions of the invention.

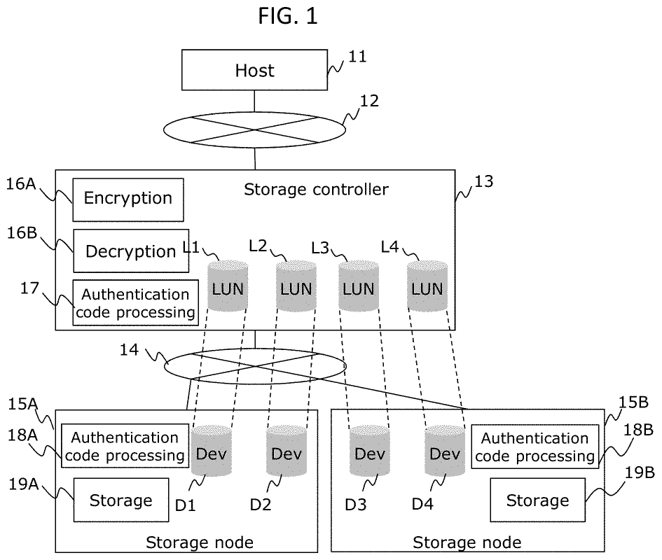

FIG. 1 is a block diagram illustrating the configurations of a storage controller and storage nodes to which an encryption apparatus according to embodiment 1 is applied.

In FIG. 1, a host 11 is coupled to a storage controller 13 via a communication network 12. The storage controller 13 is coupled to storage nodes 15A and 15B via a communication network 14. Data can be transferred between the storage controller 13 and the storage nodes 15A and 15B over a network according to such as NVMe over Fabrics.

The storage controller 13 provides logical volumes L1 to L4 for the host 11 via the communication network 12. The host 11 writes data to those logical volumes on the storage controller 13 which subsequently writes the data in capacities provided by the storage nodes 15A and 15B and read data from the storage controller 13 whose physical capacities are provided by the storage nodes 15A and 15B. The storage nodes 15A and 15B provide physical capacities for the storage controller 13 via the communication network 14.

At this point, the logical volumes L1 to L4 on the storage controller 13 can be provided so as to correspond, on a one-to-one basis, to the volumes D1 to D4 of the storage nodes 15A and 15B, respectively. The volumes D1 to D4 are, for example, physical storage devices such as a hard disk device or an SSD (Solid State Drive). The volumes indicated in the storage nodes 15A and 15B may be logical volumes or physical medium units.

The storage controller 13 publishes the logical volumes L1 to L4 to the host 11. An OS (Operating System) on the host 11 mounts the logical volumes L1 to L4 and performs IO of data.

For the logical volumes L1 to L4 specified from the host 11, the storage controller 13 transfers data, which is inputted by the IO from the host 11, between the storage nodes 15A and 15B and then writes or reads the data to or from the volumes D1 to D4 on the storage nodes 15A and 15B, the volumes D1 to D4 being provided for the respective logical volumes L1 to L4.

In this configuration, the storage system including the storage controller 13 and the storage nodes 15A and 15B is provided with an encryption apparatus in order to protect storage data to be stored in the storage nodes 15A and 15B while protecting communication data transmitted and received between the storage controller 13 and the storage nodes 15A and 15B. In the encryption, the storage controller 13 performs encryption 16A, decryption 16B, and authentication code processing 17, and the storage nodes 15A and 15B perform authentication code processing 18A and 18B and storage 19A and 19B.

In order to perform the encryption 16A and the decryption 16B, a data encryption key (hereinafter, will be also referred to as a DEK) is allocated to the storage controller 13. In order to perform authentication code processing 17, 18A, and 18B, authentication keys (hereinafter, will be also referred to as AKs) are allocated to the storage controller 13 and the storage nodes 15A and 15B. At this point, the authentication keys may be allocated to the respective storage nodes 15A and 15B or the respective volumes D1 to D4.

In the encryption 16A, encrypted data is generated using the data encryption key. In the authentication code processing 17, 18A, and 18B, authentication codes are generated using the authentication keys based on the encrypted data and the authentication codes are verified. In the decryption 16B, the encrypted data is decrypted based on the verification result of the authentication keys. In the storage 19A and 19B, the encrypted data is stored based on the verification result of the authentication keys.

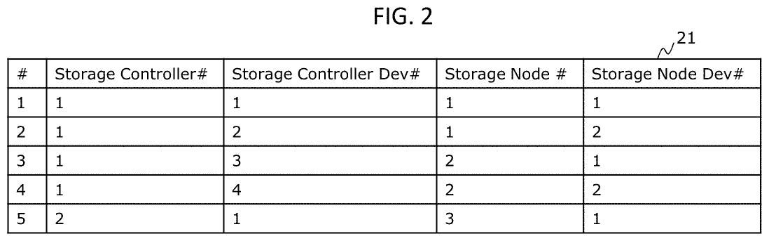

In writing, for example, when receiving a data writing request for the logical volume L1 from the host 11, the storage controller 13 performs the encryption 16A on data and generates encrypted data using the data encryption key allocated to the logical volume L1. Moreover, the storage controller 13 performs the authentication code processing 17 and generates the authentication code based on the encrypted data using the authentication key allocated to the storage node 15A. The storage controller 13 then specifies the volume D1, which corresponds to the logical volume L1, from a mapping table 21 of FIG. 2, transmits the encrypted data and the authentication code for the volume D1 to the storage node 15A via the communication network 14, and writes the encrypted data and the authentication code in the storage node 15A.

When receiving the encrypted data and the authentication code from the storage controller 13, the storage node 15A performs the authentication code processing 18A and verifies the received authentication code. When the authentication code is successfully verified, the storage node 15A performs the storage 19A and stores the encrypted data and the authentication code in the volume D1.

In reading, for example, when receiving a data reading request for the logical volume L1 from the host 11, the storage controller 13 specifies the volume D1 corresponding to the logical volume L1 from the mapping table 21 of FIG. 2 and transmits a data reading request for the volume D1 to the storage node 15A. In response to the data reading request for the volume D1, the storage controller 15A extracts the corresponding encrypted data and authentication code from the volume D1 and transmits the encrypted data and the authentication code to the storage controller 13 via the communication network 14.

When receiving the encrypted data and the authentication code from the storage node 15A, the storage controller 13 performs the authentication code processing 17 and verifies the received authentication code. When the authentication code is successfully verified, the storage controller 13 performs the decryption 16B and decrypts the encrypted data using the data encryption key allocated to the logical volume L1 and sends the decrypted data to the host 11.

The encryption of data transmitted from the storage controller 13 ensures the confidentiality of stored data in the storage nodes 15A and 15B, and the verification of the authentication code transmitted or received with encrypted data allows the checking of tampering and masquerade during data communications without implementing a communication-data encryption scheme, e.g., TLS. This eliminates the need for the encryption of communication data and the decryption of communication data in the storage controller 13 and the storage nodes 15A and 15B in order to protect data transferred between the storage controller 13 and the storage nodes 15A and 15B, thereby reducing a load for the encryption of the storage controller 13 and the storage nodes 15A and 15B.

For example, the storage controller 13 encrypts data by using a storage-data encryption scheme, e.g., AES-XTS 256 defined by IEEE P1619, and then generates a checksum for the encrypted data. From the checksum, the storage controller 13 generates the authentication code using the authentication key shared in advance with the storage nodes 15A and 15B. The storage controller 13 transmits the authentication code with the encrypted data to the storage nodes 15A and 15B.

The storage nodes 15A and 15B having received the authentication code and the encrypted data generate checksums from the encrypted data, generate the authentication codes using the authentication key shared in advance with the storage controller 13, and verify whether the authentication codes agree with the authentication code received from the storage controller 13. When the authentication codes are successfully verified, the storage nodes 15A and 15B can authenticate a transmission source and confirm the integrity of the received data. The data is encrypted according to the storage data encryption scheme during communications, so that the confidentiality is ensured.

Moreover, the storage nodes 15A and 15B store data only when the authentication code is successfully verified. This can also guarantee confidentiality and integrity when data is stored, thereby rejecting unauthorized writing from another external host or storage controller.

FIG. 2 indicates an example of the mapping table used for the storage controller of FIG. 1.

In FIG. 2, the mapping table 21 indicates the correspondence between the volume of the storage controller 13 and the volumes of the storage nodes 15A and 15B in FIG. 1.

In the mapping table 21, the entries of #, Storage Controller#, Storage Controller Dev#, Storage Node#, and Storage Node Dev# are stored. # denotes an entry number. Storage Controller# denotes identification information on the storage controller. Storage Controller Dev# denotes identification information on logical volumes provided from the storage controller. Storage Node# denotes identification information on the storage nodes. Storage Node Dev# denotes identification information on volumes provided from the storage nodes.

The mapping table 21 of FIG. 2 indicates an example in which the storage controller 13 of FIG. 1 is provided with Storage Controller#=1, the logical volumes L1 to L4 are provided with Storage Controller Dev#1 to 4, respectively, the storage nodes 15A and 15B are provided with Storage Node#=1, 2, respectively, the volumes D1 and D2 of the storage node 15A are provided with Storage Node Dev#=1, 2, respectively, and the volumes D3 and D4 of the storage node 15B are provided with Storage Node Dev#=1, 2, respectively.

In this case, referring to the mapping table 21, the storage controller 13 can determine that the logical volumes L1 and L2 of the storage controller 13 are mapped at the respective volumes D1 and D2 of the storage node 15A and the logical volumes L3 and L4 of the storage controller 13 are mapped at the respective volumes D3 and D4 of the storage node 15B. Thus, if the logical volume L1 is specified as a reading or writing target from the host 11, the storage controller 13 can actually read or write data in the volume D1 of the storage controller 13 with reference to the mapping table 21.

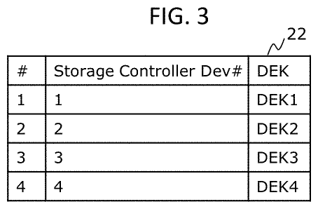

FIG. 3 indicates an example of a data-encryption-key management table used for the storage controller of FIG. 1.

In FIG. 3, a data-encryption-key management table 22 manages data encryption keys used for generating encrypted data.

In the data-encryption-key management table 22, the entries of #, Storage Controller Dev#, and DEK are stored. # denotes an entry number. Storage Controller Dev# denotes identification information on logical volumes provided from the storage controller. DEK denotes identification information on data encryption keys.

The data-encryption-key management table 22 of FIG. 3 indicates an example in which the logical volumes L1 to L4 of FIG. 1 are provided with Storage Controller Dev#1 to 4, respectively, and the logical volumes L1 to L4 are provided with data encryption keys DEK1 to DEK4, respectively.

In this case, the storage controller 13 can generate different data encryption keys for the respective logical volumes L1 to L4 with reference to the data-encryption-key management table 22. The storage controller 13 may generate data encryption keys at the time of initialization or configuration change or may cause an external key management server (hereinafter will be also referred to as KMS) to generate data encryption keys and receive the data encryption keys from the key management server.

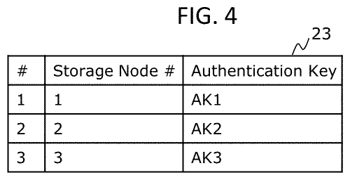

FIG. 4 indicates an example of an authentication-key correspondence table used for the storage controller of FIG. 1.

In FIG. 4, an authentication-key correspondence table 23 manages authentication keys used for generating authentication codes. FIG. 4 indicates an example in which the authentication keys are allocated in units of storage nodes.

In the authentication-key correspondence table 23, the entries of #, Storage Node#, and Authentication Key are stored. # denotes an entry number. Storage Node# denotes identification information on the storage nodes. Authentication Key denotes identification information on authentication keys.

In the case of multiple storage controllers having redundant configurations, an authentication key is shared among the storage controllers. At this point, the storage controllers with the shared authentication key can write data in the storage nodes. Each of the storage nodes manages the authentication key to be used.

The authentication key may be manually set for the storage controller 13 and the storage nodes 15A and 15B from a management UI (User Interface), may be derived from a manually set secret key, or may be shared by a key sharing algorithm, e.g., Diffie Hellman.

Furthermore, authentication keys may be created by an external KMS, and the storage controller 13 and the storage nodes 15A and 15B may receive necessary authentication keys from the KMS. At this point, access control is performed in compliance with protocols such as KMIP (Key Management Interoperability Protocol) such that only the storage controller 13 or the storage nodes 15A and 15B that belong to the correspondence can acquire the corresponding authentication key.

For example, the storage controller 13 instructs the KMS to create a required number of authentication keys, acquires the UUIDs of the authentication keys with the authentication keys from the KMS, and provides the storage nodes 15A and 15B with the UUID of the corresponding authentication key via a management interface protected by TLS or the like between the storage controller 13 and the storage nodes 15A and 15B. The storage nodes 15A and 15B then specify a UUID (Universally Unique Identifier) and acquire the authentication key through communications with the KMS protected by TLS (Transport Layer Security) or the like. Thus, the authentication key can be shared between the storage controller 13 and the storage nodes 15A and 15B.

The storage controller 13 determines that the authentication key of data written in the logical volumes L1 and L2 of the storage node 15A is AK1 with reference to the authentication-key correspondence table 23, creates the authentication code using AK1, and writes the data in the volumes D1 and D2 of the storage node 15A. The storage node 15A verifies the authentication code using AK1 that is stored in advance. When the authentication code is successfully verified, the data written in the logical volumes L1 and L2 can be stored in the volumes D1 and D2.

It is not always necessary to allocate an authentication key in units of the storage nodes 15A and 15B as indicated in FIG. 4. Authentication keys can be set in various units. For example, an authentication key can be set in units of devices of the storage nodes 15A and 15B.

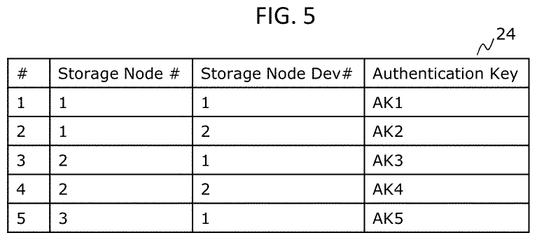

FIG. 5 indicates another example of the authentication-key correspondence table used for the storage controller of FIG. 1. FIG. 5 indicates an example in which an authentication key is allocated in units of devices of the storage nodes.

In FIG. 5, in the authentication-key correspondence table 24, the entries of #, Storage Node#, Storage Node Dev#, and Authentication Key are stored. # denotes an entry number. Storage Node# denotes identification information on the storage nodes. Storage Node Dev# denotes identification information on volumes provided from the storage nodes. Authentication Key denotes identification information on authentication keys.

The storage controller 13 determines that the authentication key of data written in the logical volume L1 of the storage node 15A is AK1 with reference to the authentication-key correspondence table 24, creates the authentication code using AK1, and writes the data in the volume D1 of the storage node 15A. The storage node 15A verifies the authentication code using AK1 that is stored in advance and is allocated to the volume D1. When the authentication code is successfully verified, the data written in the logical volume L1 can be stored in the volume D1.

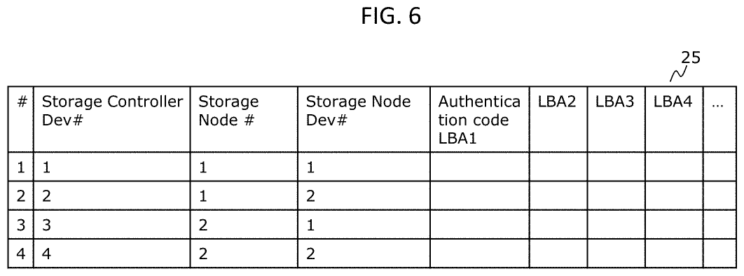

FIG. 6 indicates an example of an authentication code table used for the storage controller of FIG. 1.

In FIG. 6, an authentication code table 25 manages the latest authentication codes of data.

In the authentication code table 25, the entries of #, Storage Controller Dev#, Storage Node#, and Storage Node Dev#, and authentication codes LBA1 to LBA4 are stored. # denotes an entry number. Storage Controller Dev# denotes identification information on logical volumes provided from the storage controller. Storage Node# denotes identification information on the storage nodes. Storage Node Dev# denotes identification information on volumes provided from the storage nodes. The authentication codes LBA1 to LBA4 indicate the LBA (Logical Block Addressing) of the latest authentication codes of data.

By keeping the authentication code table 25, the storage controller 13 can confirm that data read from the storage nodes 15A and 15B is latest data. Without re-forming the authentication code during data reading in the storage controller 13, data can be protected from replay attacks by a comparison with an authentication code registered for the authentication code. In the case of multiple storage controllers having redundant configurations, information on the authentication code table 25 is also shared among the storage controllers.

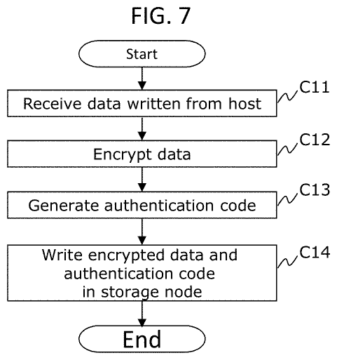

FIG. 7 is a flowchart indicating the writing of the storage controller of FIG. 1.

In FIG. 7, when receiving data written from the host 11 (C11), the storage controller 13 encrypts the data using the data encryption key allocated to the storage controller 13 (C12).

Subsequently, the authentication code is created using the authentication key shared among the storage controller 13 and the storage nodes 15A and 15B (C13), and then the encrypted data and the authentication code are written in the storage nodes 15A and 15B (C14). The data is encrypted by using, for example, schemes such as AES-XTS 256 defined by IEEE P1619. The authentication code includes information that enables verification that the writing source of the encrypted data is the storage controller 13.

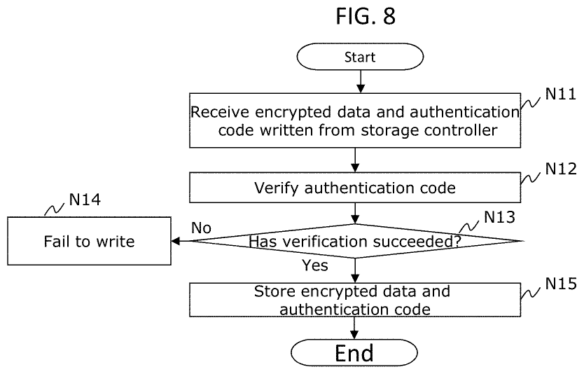

FIG. 8 is a flowchart indicating the writing of the storage nodes of FIG. 1.

In FIG. 8, when receiving the encrypted data and the authentication code that are written from the storage controller 13 (N11), the storage nodes 15A and 15B verify the authentication code (N12).

In the verification of the authentication code, the storage nodes 15A and 15B generate authentication codes using the authentication key shared with the storage controller 13 and based on the encrypted data that is received from the storage controller 13. The storage nodes 15A and 15B then confirm whether the authentication code received from the storage controller 13 agrees with the authentication codes generated by the storage nodes 15A and 15B.

As a result of the verification of the authentication code, if a proper writing source cannot be verified from information included in the authentication code, the storage nodes 15A and 15B unsuccessfully verify the authentication code (No at N13) and fail to write the data (N14), so that the encrypted data is not stored. As a result of the verification of the authentication code, if a correct writing source is successfully verified (Yes at N13), the storage nodes 15A and 15B store the encrypted data and the authentication code (N15).

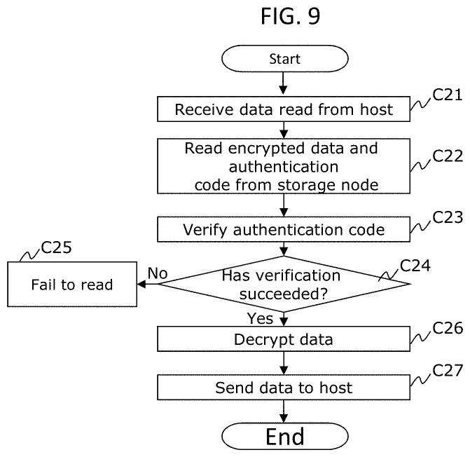

FIG. 9 is a flowchart indicating the reading of the storage controller of FIG. 1.

In FIG. 9, when receiving a reading request from the host 11 (C21), the storage controller 13 reads the encrypted data and the authentication codes from the storage nodes 15A and 15B (C22) and verifies the authentication codes (C23).

In the verification of the authentication codes, the storage controller 13 generates an authentication code using the authentication key shared with the storage nodes 15A and 15B and based on the encrypted data that is received from the storage nodes 15A and 15B. The storage controller 13 then confirms whether the authentication codes received from the storage nodes 15A and 15B agree with the authentication code generated by the storage controller 13.

If the authentication codes are unsuccessfully verified (No at C24), the storage controller 13 fails to read the data (C25). If the authentication codes are successfully verified (Yes at C24), the storage controller 13 decrypts the encrypted data that is received from the storage nodes 15A and 15B (C26) and sends the decrypted data to the host 11 (C27).

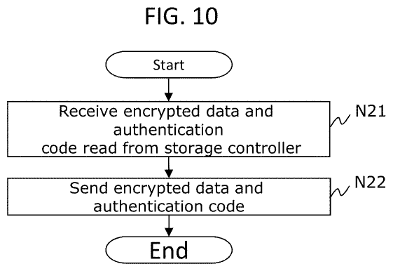

FIG. 10 is a flowchart indicating the reading of the storage nodes of FIG. 1.

In FIG. 10, when receiving a request for reading of the encrypted data and the authentication codes from the storage controller 13 (N21), the storage nodes 15A and 15B send the encrypted data and the authentication codes to the storage controller 13 (N22).

At this point, the data is encrypted and thus the data can be protected during data communications between the storage controller 13 and the storage nodes 15A and 15B. The data stored in the storage nodes 15A and 15B is encrypted and thus can be prevented from being leaked by unauthorized reading.

The assignment of the authentication codes can prevent writing in the storage nodes 15A and 15B from a storage controller other than the correct storage controller 13. Thus, the data stored in the storage nodes 15A and 15B can be prevented from being illegally corrupted. Moreover, the data read from the storage nodes 15A and 15B by the storage controller 13 can be checked for tampering.

Consequently, in data communications between the storage controller 13 and the storage nodes 15A and 15B, data can be protected from masquerade of a transmission source and data tampering without being encrypted by communication data encryption typified by FC-SP2 and TLS, thereby reducing a load for encryption.

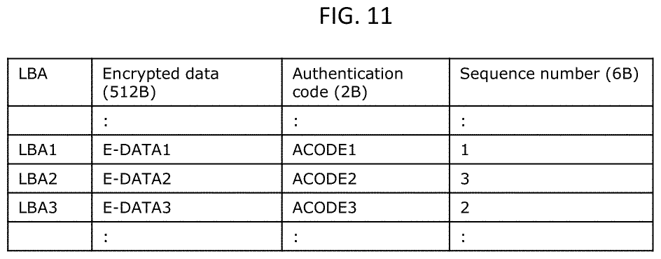

FIG. 11 indicates an example of information exchanged between the storage controller and the storage nodes of FIG. 1.

In FIG. 11, for example, encrypted data in units of 512 bytes, the authentication code of 2 bytes, and a sequence number of 6 bytes can be simultaneously transmitted or received between the storage controller 13 and the storage nodes 15A and 15B. The sequence number is a serial number of transmission of encrypted data.

At this point, the data may be combined and stored in devices in the storage nodes 15A and 15B or the authentication code and the sequence number may be stored in different areas while being associated with LBA.

If the encrypted data, the authentication code, and the sequence number are combined and stored in the devices, the data may be stored in each of the devices. The data may be separately stored in a device for storing encrypted data and a device for storing meta-information including the authentication code and the sequence number.

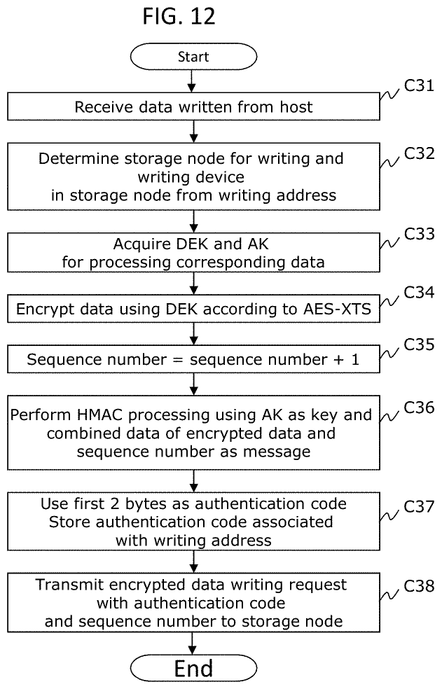

FIG. 12 is a flowchart indicating the writing of a storage controller according to a second embodiment. FIG. 12 indicates an example of the detailed processing of processing in FIG. 7.

In FIG. 12, when receiving data written from a host 11 (C31), a storage controller 13 determines, from a writing address, a storage node for writing and an address of the storage node (C32). The storage controller 13 can make the determination based on the mapping information of FIG. 2.

For example, in the configuration of FIG. 1, one logical device disclosed to the host 11 by the storage controller 13 is associated, on a one-to-one basis, with one device on storage nodes 15A and 15B for writing data written in the one logical device. Thus, referring to a mapping table 21 in FIG. 2, the storage controller 13 can determine the storage nodes 15A and 15B and the device for writing. By using LBA for which a writing instruction is provided by the host 11, the storage controller 13 performs writing on LBA of the device of the storage nodes 15A and 15B.

The storage controller 13 then acquires DEK and AK for processing data in response to a writing request (C33). The storage controller 13 can acquire DEK and AK by managing information in FIG. 3 or FIG. 4.

The storage controller 13 then encrypts data using DEK (C34). In this example, data is encrypted using AES-XTS. LBA is used as an input value in AES-XTS. Thus, if the same data has different addresses, different encrypted data segments are generated from the data.

Subsequently, the storage controller 13 advances a sequence number by one (C35). The sequence number is used for preventing replay attacks. The sequence number may be set in several types of units, for example, by a method of incrementing the sequence number in units of storage controllers or a method of incrementing the sequence number in units of pairs of the logical device of the storage controller and the device of the storage node. In this case, it is assumed that the sequence number is incremented in units of pairs of the logical device of the storage controller and the device of the storage node unless otherwise specified.

Alternatively, a random number may be generated each time instead of the sequence number or a combination of time information or the like and the sequence number may be used instead of the sequence number.

Subsequently, data is generated by concatenating the encrypted data and the sequence number and then HMAC (Hash based Message Authentication Code) processing is performed using AK as a key and the concatenated data as a message (C36). At this point, the first 2 bytes of the message can be used as an authentication code.

The storage controller 13 then stores the authentication code associated with LBA in the storage controller 13 (C37). At this point, the latest authentication code of corresponding LBA is written over an authentication code table 25 of FIG. 6.

The storage controller 13 then writes the encrypted data with the authentication code and the sequence number in plain text in the storage nodes 15A and 15B (C38).

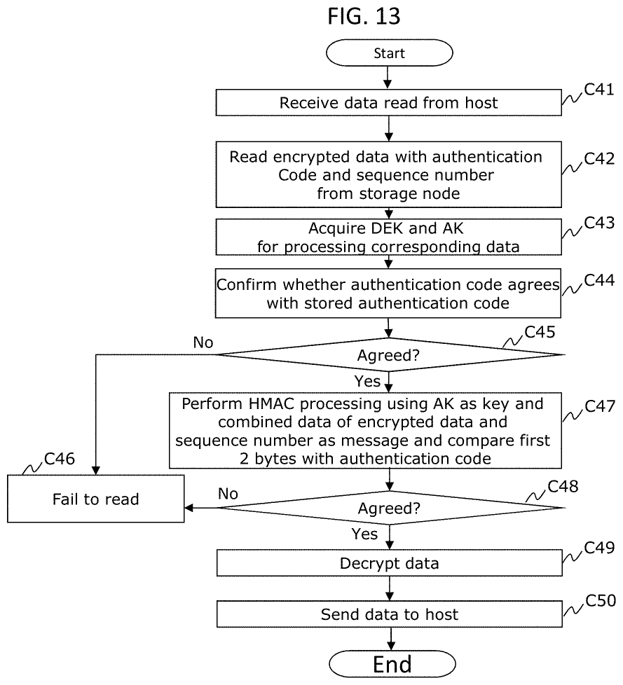

FIG. 13 is a flowchart indicating the reading of the storage controller according to the second embodiment. FIG. 13 indicates an example of the detailed processing of processing in FIG. 9.

In FIG. 13, when receiving a data reading request with LBA from the host 11 (C41), the storage controller 13 reads the encrypted data, the authentication code associated with the encrypted data, and the sequence number from corresponding LBA of the storage nodes 15A and 15B (C42) and acquires DEK and AK for processing corresponding data (C43).

Subsequently, the storage controller 13 performs two verifications as verification of the authentication code in C23 of FIG. 9. In the first verification, the storage controller 13 confirms whether the authentication codes read from the storage nodes 15A and 15B agree with the authentication code stored in corresponding LBA in FIG. 6 (C44). Thus, even data correctly written in the past in the storage nodes 15A and 15B by the storage controller 13 is prevented from being read because the data is not the latest data.

If the authentication codes do not agree with each other (No at C45), the storage controller 13 fails to read the data and completes the process (C46). If the authentication codes agree with each other (Yes at C45), the storage controller 13 generates, as the second verification, an authentication code according to the same method of generating the authentication code in the processing of FIG. 12 and compares the authentication code with the authentication codes acquired from the storage nodes 15A and 15B (C47). If the authentication codes do not agree with each other (No at C48), the storage controller 13 fails to read the data and completes the process (C46). If the authentication codes agree with each other (Yes at C48), the storage controller 13 decrypts the encrypted data that is received from the storage nodes 15A and 15B (C49) and sends the data to the host 11 (C50).

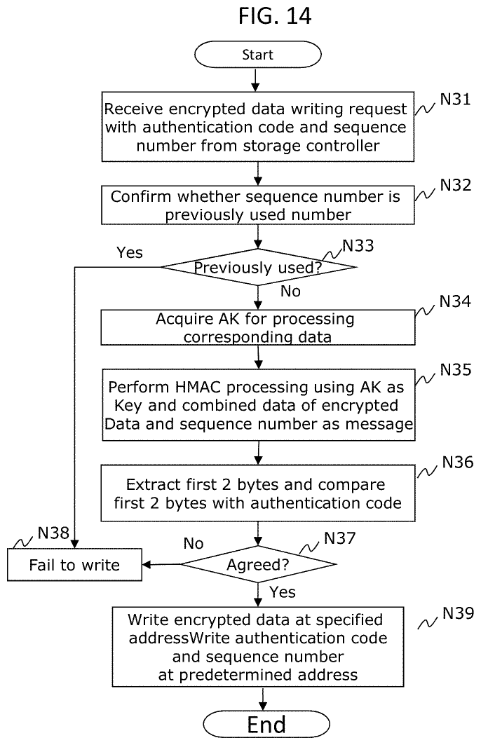

FIG. 14 is a flowchart indicating the writing of the storage nodes according to the second embodiment. FIG. 14 indicates an example of the detailed processing of processing in FIG. 8.

In FIG. 14, when receiving the encrypted data with the authentication code and the sequence number in plain text from the storage controller 13 (N31), the storage nodes 15A and 15B confirms whether the sequence number is a previously used number (N32). In order to determine whether the sequence number is a previously used number, the storage nodes 15A and 15B store sequence numbers received in the past. If the sequence number is a previously used number (Yes at N33) the storage nodes 15A and 15B fail to write the data and completes the process (N38).

If the sequence number is not a previously used number (No at N33) the storage nodes 15A and 15B refer to an authentication-key correspondence table 24 in FIG. 5 and acquire AK for processing the data received in N31 (N34).

From the encrypted data and the sequence number, the storage nodes 15A and 15B then concatenate the data according to the same method as the processing of C36 in FIG. 12 and perform HMAC processing using AK as a key (N35). Subsequently, the storage nodes 15A and 15B compare the first 2 bytes of information generated by the HMAC processing with the authentication code received from the storage controller 13 (N36). If the authentication codes do not agree with each other (No at N37), the storage nodes 15A and 15B fails to write the data and completes the process (N38). If the authentication codes agree with each other (Yes at N37), the storage nodes 15A and 15B store the encrypted data at a specified address and store the authentication codes and the sequence number at a predetermined address (N39).

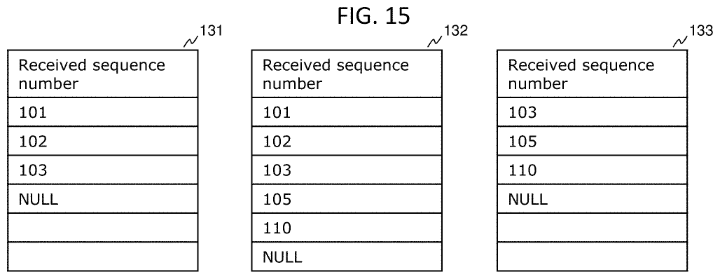

FIG. 15 indicates a method of confirming whether the sequence number is a previously used number.

In FIG. 15, in order to determine whether the sequence number is a previously used number, the storage nodes 15A and 15B manage received sequence number lists 131 to 133.

In the received sequence number list 131, if sequence numbers included in received data are regarded as being unreceived, the sequence numbers are added in ascending order. In this example, latest sequence numbers 101 to 103 are registered. NULL is described at the ends of the received sequence number lists 131 to 133. NULL is used for determining the ends of the received sequence number lists 131 to 133.

At this point, the three sequence numbers 101 to 103 are consecutive numbers. Thus, in order to confirm whether the sequence numbers are previously used numbers, only the sequence number 103 may be left and the sequence numbers 101 and 102 may be deleted. The storage nodes 15A and 15B can confirm that the sequence numbers equal to or smaller than the sequence number 103 have been received, from information on the sequence number 103.

If communications are not lost and a receiver sequentially receives the sequence numbers as issued by a sender, the storage nodes 15A and 15B can determine whether the sequence numbers are previously used numbers only by holding the last sequence number.

The received sequence number list 132 indicates that sequence numbers 101 to 103, 105, and 110 are received after the reception of sequence numbers up to 100. At this point, the sequence numbers 101 to 103 are consecutive numbers and thus the sequence numbers 101 and 102 can be deleted from the received sequence number list 132 and only the sequence numbers 103, 105, and 110 may be stored in the received sequence number list 133. If an additionally received sequence number is at most the first sequence number 103 or agrees with other sequence numbers (in this case, 105 and 110), the sequence number is regarded as being received. Otherwise the sequence number is regarded as being unreceived.

Processing continued for a certain period of time may cause an overflow of a received sequence number and thus numbering from 0 may be necessary. In such a case, a sufficiently large number of digits is used to prevent unauthorized use of past sequence numbers as in the use of ordinary sequence numbers. Moreover, received sequence numbers may not be storable in memory after the processing is continued for a certain period of time. In this case, it is necessary to discard some of the received sequence numbers, determine the sequence numbers not larger than the maximum discarded sequence number are received sequence numbers, and reject the reception of the sequence numbers.

When writing the encrypted data that is received from the storage controller 13, the storage nodes 15A and 15B may write the encrypted data, the authentication code, and the sequence number in different messages. For example, the storage nodes 15A and 15B may wait for writing until the authentication code and the sequence number reach multiples of 512 bytes, and then collectively write the authentication code and the sequence number that have reached multiples of 512 bytes.

In this case, the storage nodes 15A and 15B verify written data after the authentication code and the sequence number of the corresponding encrypted data are received. In this case, if the storage nodes 15A and 15B cannot receive the authentication code and the sequence number for a predetermined period of time, the storage nodes 15A and 15B send signals indicating the discontinuation of the processing to the storage controller 13. When receiving the signals, the storage controller 13 discontinues the writing, thereby preventing a data loss.

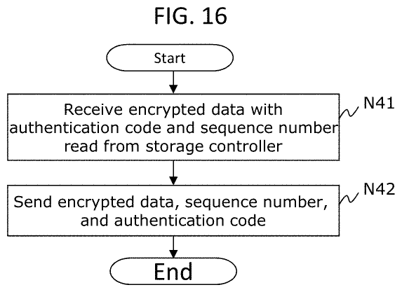

FIG. 16 is a flowchart indicating the reading of the storage nodes according to the second embodiment. FIG. 16 indicates an example of the detailed processing of processing in FIG. 10.

In FIG. 16, when receiving a reading request of the encrypted data with the authentication code and the sequence number from the storage controller 13 (N41), the storage nodes 15A and 15B send the authentication code, the sequence number, and the encrypted data to the storage controller 13 (N42).

In the example of FIG. 16, the reading request of the encrypted data is received with the authentication code and the sequence number from the storage controller 13. The storage nodes 15A and 15B may manage the encrypted data and the authentication code and the sequence number that are associated with the encrypted data. When the storage controller 13 requests only reading of the encrypted data, the authentication code and the sequence number may be sent with the encrypted data to the storage controller 13.

In the reading of the storage controller in FIG. 13, the method of performing two verifications was described as verification of the authentication code in C23 of FIG. 9. However, it is assumed that illegal corruption and tampering of data on the storage nodes 15A and 15B can be prevented in the writing of the storage controller in FIG. 12. When data is read, a host application may be capable of detecting corruption and tampering of data. The data may be readable again. In this case, at least part of the two verifications in FIG. 13 may be omitted.

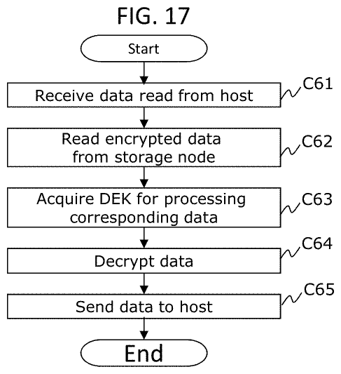

FIG. 17 is a flowchart indicating the reading of a storage controller according to a third embodiment. In the example of FIG. 17, both of the two verifications in FIG. 13 may be omitted.

In FIG. 17, when receiving a reading request from a host 11 (C61), a storage controller 13 reads encrypted data from storage nodes 15A and 15B (C62).

The storage controller 13 then acquires DEK for processing the encrypted data that is received from the storage nodes 15A and 15B (C63), decrypts the encrypted data using DEK (C64), and sends the data to the host 11 (C65).

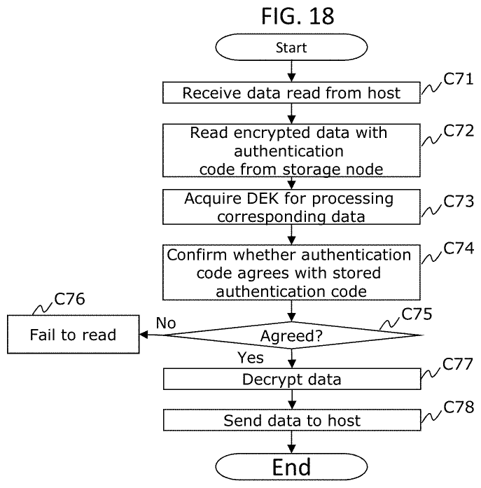

FIG. 18 is a flowchart indicating the reading of a storage controller according to a fourth embodiment. In the example of FIG. 18, the second verification of the two verifications in FIG. 13 is omitted.

In FIG. 18, when receiving a data reading request from a host 11 (C71), a storage controller 13 reads encrypted data (C72) and authentication codes associated with the encrypted data from storage nodes 15A and 15B, and acquires DEK for processing corresponding data (C73).

The storage controller 13 then confirms whether the authentication codes read from the storage nodes 15A and 15B agree with an authentication code held by the storage controller 13 (C74).

If the authentication codes do not agree with each other (No at C75), the storage controller 13 fails to read the data and completes the process (C76). If the authentication codes agree with each other (Yes at C75), the storage controller 13 decrypts the encrypted data that is received from the storage nodes 15A and 15B (C77) and sends the data to the host 11 (C78).

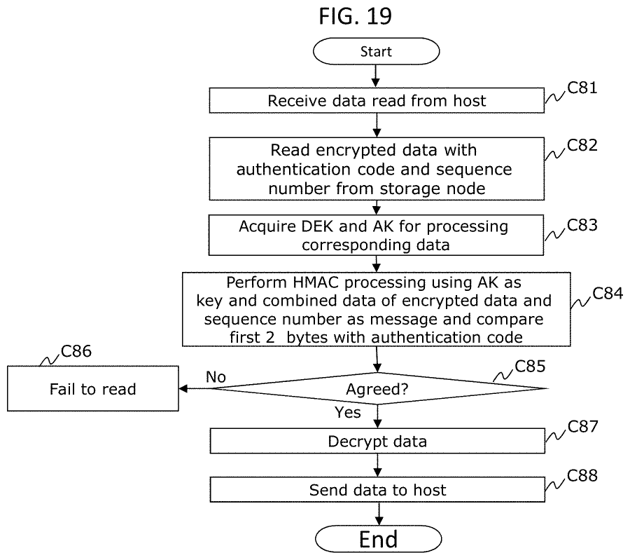

FIG. 19 is a flowchart indicating the reading of a storage controller according to a fifth embodiment. In the example of FIG. 19, the first verification of the two verifications in FIG. 13 is omitted.

In FIG. 19, when receiving a data reading request from a host 11 (C81), a storage controller 13 reads encrypted data, authentication codes associated with the encrypted data, and a sequence number from storage nodes 15A and 15B (C82) and acquires DEK and AK for processing corresponding data (C83).

The storage controller 13 then generates an authentication code by the same method as in the generation of the authentication code in the processing of FIG. 12, and compares the authentication code with the authentication codes acquired from the storage nodes 15A and 15B (C84). If the authentication codes do not agree with each other (No at C85), the storage controller 13 fails to read the data and completes the process (C86). If the authentication codes agree with each other (Yes at C85), the storage controller 13 decrypts the encrypted data that is received from the storage nodes 15A and 15B (C87) and sends the data to the host 11 (C88).

In the reading of FIG. 13, the storage controller 13 holds the authentication codes therein and verifies that read data is the latest data by comparing the authentication codes during reading, thereby preventing replay attacks using past data.

In order to prevent replay attacks using past data, the storage nodes 15A and 15B may generate new authentication codes according to a scheme similar to the method of FIG. 12 using sequence numbers generated in the storage nodes 15A and 15B, and the storage controller 13 may verify the new authentication codes.

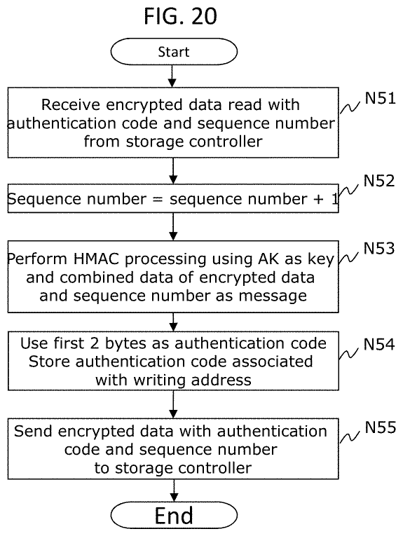

FIG. 20 is a flowchart indicating the reading of storage nodes according to a sixth embodiment. FIG. 12 indicates the method of managing sequence numbers by the storage controller, whereas FIG. 20 indicates a method of managing sequence numbers by storage nodes.

In FIG. 20, storage nodes 15A and 15B receive encrypted data read with an authentication code and a sequence number from a storage controller 13 (N51). The storage nodes 15A and 15B then advance the sequence number by one (N52).

Subsequently, the storage nodes 15A and 15B perform HMAC processing using AK as a key and data generated by concatenating the encrypted data and the sequence number as a message (N53). The storage nodes 15A and 15B then use the first 2 bytes of the message as an authentication code and store the authentication code associated with a writing address in the storage nodes 15A and 15B (N54).

Subsequently, the storage nodes 15A and 15B send the encrypted data with the authentication code and the sequence number to the storage controller 13 (N55).

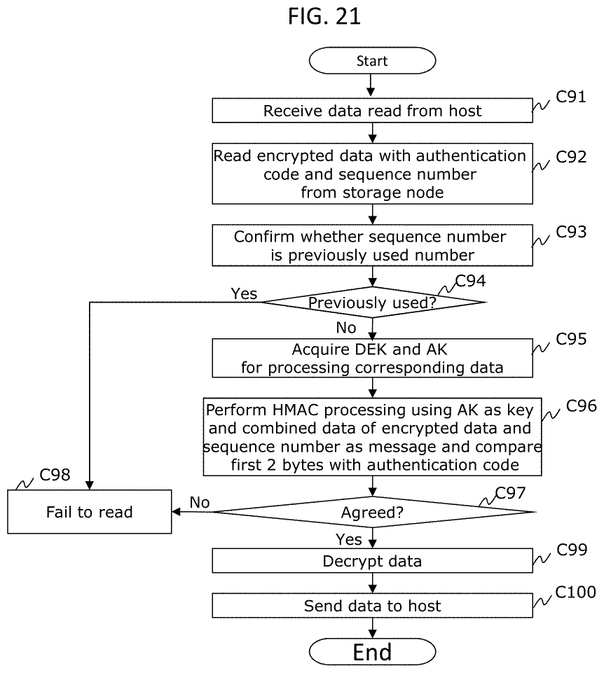

FIG. 21 is a flowchart indicating the reading of the storage controller according to the sixth embodiment. FIG. 13 indicates the method of managing sequence numbers by the storage controller, whereas FIG. 21 indicates the method of managing sequence numbers by the storage nodes.

In FIG. 21, when receiving a data reading request from a host 11 (C91), the storage controller 13 reads the encrypted data with the authentication code and the sequence number from the storage nodes 15A and 15B (C92).

The storage controller 13 then confirms whether sequence numbers read from the storage nodes 15A and 15B agree with a sequence number used in the past (C93). In order to determine whether the sequence numbers are previously used numbers, the storage controller 13 stores sequence numbers received in the past.

If the sequence numbers read from the storage nodes 15A and 15B are previously used numbers (Yes at C94), the storage controller 13 fails to read the data and completes the process (C98). If the sequence numbers read from the storage nodes 15A and 15B are not previously used numbers (No at C94), the storage controller 13 acquires DEK and AK for processing the data (C95).

From the encrypted data and the sequence numbers, the storage controller 13 then concatenates the data according to the same method as the processing of C36 in FIG. 12 and performs HMAC processing using AK as a key. Subsequently, the storage controller 13 compares the first 2 bytes of information generated by the HMAC processing with the authentication codes received from the storage nodes 15A and 15B (N96).

If the authentication codes do not agree with each other (No at C97), the storage controller 13 fails to read the data and completes the process (C98). If the authentication codes agree with each other (Yes at C97), the storage controller 13 decrypts the encrypted data that is received from the storage nodes 15A and 15B (C99) and sends the data to the host 11 (C100).

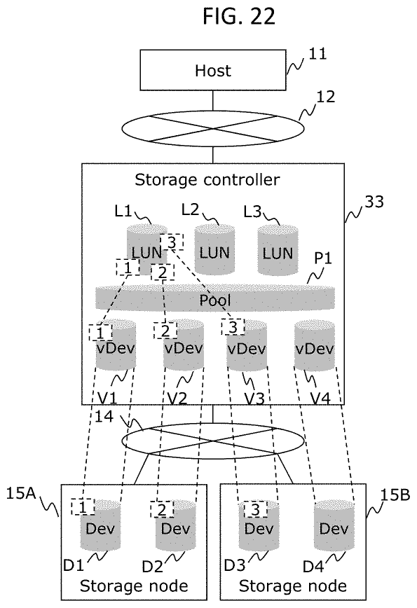

FIG. 22 is a block diagram illustrating the configurations of a storage controller and storage nodes to which an encryption apparatus according to a seventh embodiment is applied.

In a storage system illustrated in FIG. 22, the storage controller 13 of FIG. 1 is replaced with a storage controller 33.

The storage controller 33 manages logical volumes L1 to L3 via a pool P1. The units of the data area of the pool P1 are disposed in volumes D1 to D4 of at least one storage node 15A or 15B in a distributed manner. At this point, the storage controller 33 generates pool volumes V1 to V4 for the volumes D1 to D4, respectively, and centralizes the pool volumes V1 to V4 at the pool P1. Furthermore, the storage controller 33 extracts the logical volumes L1 to L3 from the pool P1 and provides the logical volumes for the host 11.

Except for the method of managing the logical volumes L1 to L3 via the pool P1, the storage controller 33 performs encryption 16A, decryption 16B, and authentication code processing 17 like the storage controller 13.

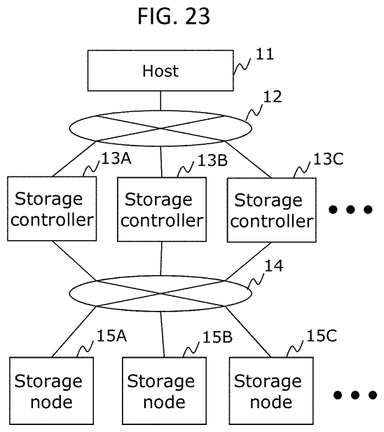

FIG. 23 is a block diagram illustrating the configurations of a storage controller and storage nodes to which an encryption apparatus according to an eighth embodiment is applied.

In FIG. 23, storage controllers 13A to 13C . . . are coupled to storage nodes 15A to 15C . . . via a network 14. The storage controllers 13A to 13C perform encryption 16A, decryption 16B, and authentication code processing 17 like the storage controller 13 of FIG. 1.

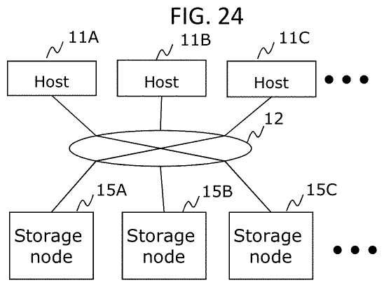

FIG. 24 is a block diagram illustrating the configurations of hosts and storage nodes to which an encryption apparatus according to a ninth embodiment is applied.

In FIG. 24, a plurality of hosts 11A to 11C . . . are coupled to a plurality of storage nodes 15A to 15C . . . via a network 12. The hosts 11A to 11C . . . perform processing identical or similar to the host 11 of FIG. 1 and have functions identical or similar to the storage controller 13 so as to perform processing identical or similar to the storage controller 13.

Thus, even if the hosts 11A to 11C . . . write or read data to or from the storage nodes 15A to 15C . . . without a storage controller, the safety of data storage and communications can be secured while reducing a load for encryption.

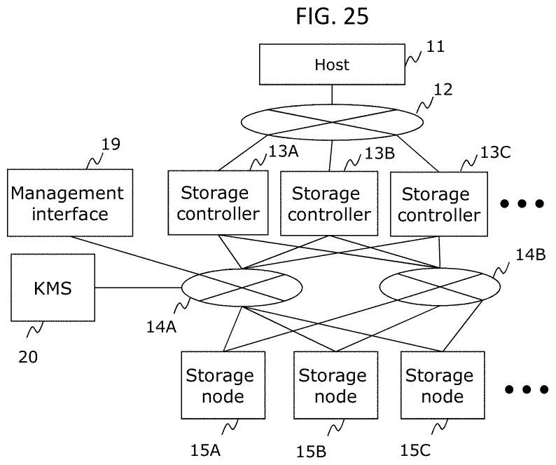

FIG. 25 is a block diagram illustrating the configurations of a storage controller and storage nodes to which an encryption apparatus according to a tenth embodiment is applied.

In FIG. 25, a host 11 is coupled to storage controllers 13A to 13C . . . via a network 12. The storage controllers 13A to 13C . . . are coupled to storage nodes 15A to 15C via a network 14B.

Moreover, the storage controllers 13A to 13C . . . and the storage nodes 15A to 15C . . . are coupled to a management interface 19 and a KMS 20 via a network 14A.

The KMS 20 manages DEK and AK, provides DEK for the storage controllers 13A to 13C . . . , and provides AK for the storage controllers 13A to 13C . . . and the storage nodes 15A to 15C . . . via the network 14A. The KMS 20 and the storage controllers 13A to 13C . . . are coupled to each other and the KMS 20 and the storage nodes 15A to 15C . . . are coupled to each other in accordance with, for example, a KMIP protocol by using communication security techniques such as TLS. The KMS 20 may be coupled on the network 14A between the storage controllers 13A to 13C . . . and the storage nodes 15A to 15C . . . or another network that is different from a data network.

The management interface 19 provides an GUI (Graphical User Interface) or a CLI (Command Line Interface) for a user and manages, for example, the allocation of DEK and AK. In order to prevent fraud in the management interface 19, the management interface 19 also performs management including a deletion of a volume from a network protected by communication security such as TLS.

The foregoing embodiments described the method of reading and writing data in the storage nodes 15A and 15B, in which the authentication code processing 18A and 18B are implemented, by the storage controller 13. Also in the case of reading and writing of data in a storage having a single function, leakage of data can be prevented and tampering of data can be detected.

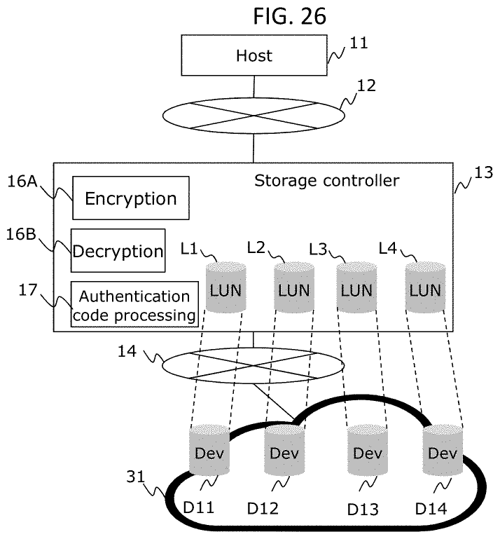

FIG. 26 is a block diagram illustrating the configurations of a storage controller and a storage to which an encryption apparatus according to an eleventh embodiment is applied.

In FIG. 26, a cloud 31 is coupled to a network 14 instead of the storage nodes 15A and 15B of FIG. 1. The cloud 31 provides volumes D11 to D14 for a storage controller 13.

When receiving data written from a host 11, the storage controller 13 encrypts the data using a data encryption key allocated to the storage controller 13. The storage controller 13 then generates an authentication code using an authentication key allocated to the storage controller 13 and writes the encrypted data and the authentication code to the volumes D11 to D14. The volumes D11 to D14 store the encrypted data and the authentication code, which are received from the storage controller 13, without verifying the authentication code.

When receiving a reading request from a host 11, the storage controller 13 reads the encrypted data and the authentication code from the volumes D11 to D14 and verifies the authentication code. If the authentication code is successfully verified, the storage controller 13 decrypts the encrypted data that is received from the volumes D11 to D14 and sends the decrypted data to the host 11. Thus, even if data is written or read in the volumes D11 to D14, each having a single function, the storage controller 13 can prevent leakage of data and tampering of data.

In the foregoing embodiments, the method of generating the authentication code using HMAC was described. Another algorithm may be used as long as the authentication code is generated. Moreover, in the foregoing embodiments, the 2-byte authentication code is generated. The number of bytes is not limited to 2. Alternatively, the authentication code may not be stored in N15 of FIG. 8 or may not be verified in C23 of FIG. 9 depending upon the risk of security.

In the foregoing embodiments, leakage of data in the storage nodes is prevented by separating DEK and AK. It is not necessary to separate DEK and AK as long as the storage nodes are operated in sufficiently reliable circumstances. In this case, hash functions not using keys or methods such as CRC (Cyclic Redundancy Check) are used instead of HMAC so as to generate a checksum for data concatenated with a sequence number before encryption. In this case, AK is not used.

The above-mentioned encryption, decryption, and authentication can be used for the authentication of a command as well as IO.

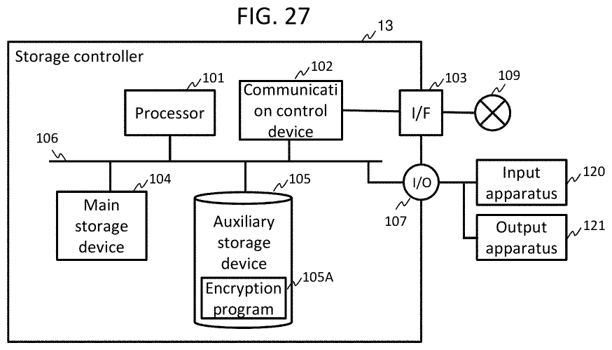

FIG. 27 is a block diagram illustrating a hardware configuration example of the storage controller of FIG. 1.

In FIG. 27, the storage controller 13 includes a processor 101, a communication control device 102, a communication interface 103, a main storage device 104, an auxiliary storage device 105, and an input/output interface 107. The processor 101, the communication control device 102, the communication interface 103, the main storage device 104, the auxiliary storage device 105, and the input/output interface 107 are coupled to one another via an internal bus 106. The main storage device 104 and the auxiliary storage device 105 are accessible from the processor 101.

Moreover, an input apparatus 120 and an output apparatus 121 are provided outside the storage controller 13. The input apparatus 120 and the output apparatus 121 are coupled to the internal bus 106 via the input/output interface 107. The input apparatus 120 is, for example, a keyboard, a mouse, a touch panel, a card reader, or a voice input apparatus. The output apparatus 121 is, for example, a screen display (e.g., a liquid crystal monitor, an organic EL (Electro Luminescence) display, or a graphic card), an audio output apparatus (speaker or the like), or a printer.

The processor 101 is hardware that controls the operations of the overall storage controller 13. The processor 101 may be a CPU (Central Processing Unit) or a GPU (Graphics Processing Unit). The processor 101 may be a single-core processor or a multi-core processor. The processor 101 may include a hardware circuit (e.g., an FPGA (Field-Programmable Gate Array) or an ASIC (Application Specific Integrated Circuit)) that performs at least part of processing. The processor 101 may include a neural network.

The main storage device 104 may include a semiconductor memory, for example, SRAM or DRAM. In the main storage device 104, a program being executed by the processor 101 may be stored or a work area for executing a program by the processor 101 may be provided.

The auxiliary storage device 105 is a storage device having a large storage capacity, for example, a hard disk apparatus or an SSD. The auxiliary storage device 105 can hold the executable files of various programs and data used for executing the programs. In the auxiliary storage device 105, an encryption program 105A can be stored. The encryption program 105A may be software installable in the storage controller 13 or firmware installed in the storage controller 13.

The communication control device 102 is hardware having the function of controlling communications with the outside. The communication control device 102 is coupled to a network 109 via the communication interface 103. The network 109 may be a WAN (Wide Area Network), e.g., the Internet, a LAN (Local Area Network), e.g., WiFi or Ethernet (registered trademark), or a combination of a WAN and a LAN.

The input/output interface 107 converts data inputted from the input apparatus 120 into a data format processable to the processor 101, or converts data outputted from the processor 101 into a data format processable to the output apparatus 121.

The processor 101 reads the encryption program 105A into the main storage device 104 and then the encryption program 105A is executed, so that the encryption 16A, the decryption 16B, and the authentication code processing 17 in FIG. 1 can be implemented.

The execution of the encryption program 105A may be shared among a plurality of processors or computers. Alternatively, the processor 101 may instruct a cloud computer or the like via the network 109 to execute at least part of the encryption program 105A, and receive the result of execution.

The present invention is not limited to the foregoing embodiments and includes various modifications. For example, the embodiments were specifically described to illustrate the present invention. All the described configurations are not necessary for the present invention. Moreover, the configuration of one of the embodiments can be partially replaced with the configuration of another embodiment or the configuration of one of the embodiments may further include the configuration of another embodiment. Alternatively, the configurations of the embodiments can partially include additional configurations, can be partially deleted, or can be partially replaced with other configurations. The configurations, functions, processing unit, and processing means may be partially or entirely implemented by hardware, for example, an integrated circuit design.

What is claimed is:

1. A storage system comprising: a controller to which an authentication key is allocated; and a node,
wherein the controller is configured to
generate encrypted data in which the data is encrypted using a data encryption key,
generate an authentication code based on the encrypted data using the authentication key, and
transmit the encrypted data and the authentication code to the node,
the node is configured to
receive the encrypted data and the authentication code that are transmitted from the controller,
store the encrypted data and the authentication code, and
transmit the encrypted data and the authentication code that are stored to the controller, and
the controller is further configured to
receive the encrypted data and the authentication code that are transmitted from the node, and
decrypt the encrypted data based on a verification result of the authentication code transmitted from the node.

2. The storage system according to claim 1, wherein the node is configured to store the encrypted data and the authentication code based on a verification result of the authentication code transmitted from the controller.

3. The storage system according to claim 1, wherein the node is configured to
read the encrypted data and the authentication code that are stored, and
transmit the encrypted data and the authentication code that are read to the controller.

4. The storage system according to claim 1, wherein the controller is configured to generate the authentication code based on the encrypted data and a sequence number that is a serial number of transmission of the encrypted data.

5. The storage system according to claim 2, wherein the controller and the node are coupled to each other via a communication network.

6. The storage system according to claim 5, wherein a key management server for managing the data encryption key and the authentication key provides the authentication key for the controller and the node and provides the data encryption key for the controller, via the communication network.

7. The storage system according to claim 1, wherein the node is configured to
generate the authentication code based on the encrypted data and a sequence number that is a serial number of transmission of the encrypted data using the authentication key, and
the controller is configured to
receive the encrypted data, the authentication code, and the sequence number from the node, and
decrypt the encrypted data based on a verification result of the received authentication code.

8. A storage system comprising: a host to which an authentication key is allocated; and a node,
wherein the host is configured to
generate encrypted data in which the data is encrypted using a data encryption key,
generate an authentication code based on the encrypted data using the authentication key, and
transmit the encrypted data and the authentication code to the node,
the node is configured to
receive the encrypted data and the authentication code that are transmitted from the host,
store the encrypted data and the authentication code based on a verification result of the authentication code transmitted from the host, and
transmit the encrypted data and the authentication code that are stored to the host, and
the host is further configured to
receive the encrypted data and the authentication code that are transmitted from the node, and
decrypt the encrypted data based on a verification result of the authentication code transmitted from the node.

9. A data protection method for a storage system in which data transmitted from a sender is stored by a receiver,
wherein the sender
generate encrypted data in which the data is encrypted using a data encryption key,
generates an authentication code based on the encrypted data using an authentication key, and
transmits the encrypted data and the authentication code to the receiver, and
the receiver
receives the encrypted data and the authentication code that are transmitted from the sender,
stores the encrypted data and the authentication code, and
transmits the encrypted data and the authentication code that are stored to the sender, and
the sender
receives the encrypted data and the authentication code that are transmitted from the receiver, and
decrypts the encrypted data based on a verification result of the authentication code transmitted from the receiver.

10. The data protection method for a storage system according to claim 9, wherein the receiver stores the encrypted data and the authentication code based on a verification result of the authentication code transmitted from the sender.
